(19) United States
(12) Patent Application Publication
(10) Pub. No.: US 2002/0017530 A1
(43) Pub. Date: Feb. 14, 2002

(54) System for the activation of the coin selector for cigarette vending machines

(76) Inventor: Felix Guindulain Vidondo, Peralta (ES)

Correspondence Address: KLAUBER & JACKSON, 411 HACKENSACK AVENUE, HACKENSACK, NJ, 07601

(21) Appl. No.: 09/880,171

(22) Filed: Jun. 13, 2001

(30) Foreign Application Priority Data
Aug. 2, 2000 (ES) 200001978

(51) Int. Cl. G07F 11/00

(52) U.S. Cl. 221/9

(57) ABSTRACT

System for the activation of the coin selector for cigarette vending machines, being of the type of cigarette vending machines that include a coin selector for validation thereof, the system comprising activating means of the selector of the machine, for a certain amount of time, for the recognition of the coins inserted for the purchase of the desired product, supervising and controlling the sale of cigarettes.

### OBJECT OF THE INVENTION

As expressed in the title of the present specification, the following invention refers to a system for the activation of the coin selector for cigarette vending machines, being of the type of cigarette vending machines that operate by means of the insertion of coins, which have a coin selector that validates the same when they are inserted, in such a way that the system for the activation of the coin selector makes the coin validating system activate prior to the insertion of the coins. This operation is carried out by means of the introduction of a token whose characteristics are recorded in the memory itself of the electronic control and operating system of the machine itself and when the token is recognized by the selector itself, the selector is activated for the validation of the coins.

Hence, the user who is going to use the cigarette vending machine should first of all insert the corresponding token, provided by the supervisor or person in charge of the premises, the selector of the machine drawing information from said token and comparing it with the information stored in the memory itself, accepting it if it coincides and activating the coin validating system, which will then act like it conventionally does.

In this way, the activating token should be provided by a supervisor or person in charge of the premises where the cigarette vending machine is installed, providing the token only to those authorized users, in other words, those of age.

In short, it is a question of those possible users who do not have the activating token of the coin selector system from not being able to freely purchase cigarette and that cigarettes can only be bought by those people of age to whom the person in charge of the premises where the machine is installed provides the corresponding token, so that it is inserted before the coins are inserted in order to purchase the desired product.

Hence, it is a question of having a supervised and control system for selling cigarettes so that cigarettes may only be purchased from the vending machines by persons to whom a person in charge of the machine provides the token that activates the coin selector, whereas if the token is not inserted the machine does not validate the coins, and they will be directly returned.

### FIELD OF THE APPLICATION

The system for the activation of the coin selector is especially applicable to be included in cigarette vending machines, in such a way that in order for the machine to be able to validate coins before the coins to be validated are inserted, a token provide should be inserted.

### BACKGROUND OF THE INVENTION

Numerous cigarette vending machines are installed in public places where the users have direct access to the machines, in such a way that by means of the insertion of the correct amount the desired cigarettes can be purchased.

Hence, in numerous places the supervisor or person in charge cannot continuously watch to see the users of the cigarette vending machine and hence, it is easy for minors to be able to purchase cigarettes.

This is the case, given that cigarette vending machines validate coins directly while the coins are being inserted.

On the other hand, we can cite patent of invention P9801480 which describes and claims a vending machine, and more specifically a cigarette vending machine, which includes a radio frequency receiver for the reception of waves emitted by a radio frequency emitter, in such a way that when a user wishes to purchase a product from the cigarette vending machine the amount of the purchase is paid to the person in charge of the premises, in such a way that when the radio frequency emitter is activated the radio frequency receiver receives the order to activate the product selecting mechanism so that the user selects the desired product.

Hence, the cigarette vending machine does not have a selector and the person in charge himself of the premises activates the selecting mechanism by means of the use of remote control, in such a way that in this case there is a certain amount of control by the person in charge of the premises where the machine is installed, but there is also the inconvenience that on occasions the person in charge of the premises cannot directly see the machine and thus when the machine is activated a third party may choose the product.

### DESCRIPTION OF THE INVENTION

For the purpose of overcoming the cited inconveniences and as a means to supervise the sale of cigarettes by cigarette vending machines, the present specification describes a system for the activation of the coin selector for cigarette vending machines, being of the type of cigarette vending machines that operate by means of inserting coins, machines which have a coin selector that validates the coins as they are inserted, the system comprising activating means of the selector of the machine for a certain amount of time, for the recognition of the coins inserted for the purchase of the desired product, supervising and controlling the sale of cigarettes.

The activating means of the coin selector system are defined by a token of specific characteristics recorded in the memory of the electronic and operating system of the machine. When the token is inserted and recognized by the selector, the selector is activated for a certain amount of time for the validation of coins and the dispensing of a single product, guaranteeing that the person who takes out the product is the one who inserted the token.

The coin selector of the machine solely and exclusively validates coins if the activating token of the coin selector system has been inserted and recognized, guaranteeing that cigarettes are only purchased by people of age to whom the person in charge or supervisor of the premises has provided the corresponding token in order to activate the selector for the validation of coins.

The supervision and control of the sale of cigarettes are defined by the activating token of the coin selector which is provided by a person in charge of the premises where the cigarette vending machine is installed. Once the token has been recognized by the selector it is stored in a money box of the machine itself and it cannot be returned to the receiving box.

In order to complete the description that is going to be made hereinafter and for the purpose of providing a better understanding of the characteristics of the invention, the present specification is accompanied by a diagram in whose sole FIGURE the most characteristics details of the invention are represented in an illustrative and non-restrictive manner.

### BRIEF DESCRIPTION OF THE DRAWINGS

FIG. 1 shows a schematic view of the sequence followed in the insertion of a token in order to activate the selector system for the subsequent validation of coins in cigarette vending machines.

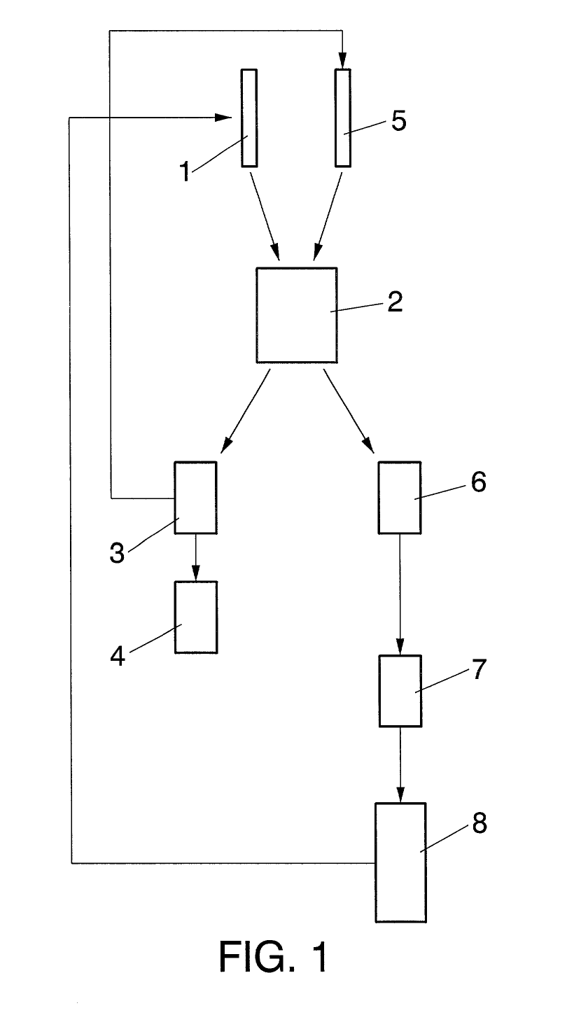

### DESCRIPTION OF A PREFERRED EMBODIMENT

In view of the commented FIGURE and in accordance with the numbering used, we can see how when a token (1) with certain characteristics is inserted, the selector (2) of the machine draws the parameters thereof provided for in order to compare them with the parameters recorded in the memory itself of the control and operating system, in such a way that if the token (1) is recognized and validated the activation (3) of the selector itself (2) in order to validate the coins is caused, for a certain amount of time, the token (1) going to the money box (4) existing in the machine for this purpose.

Once the selector (2) is activated for the validation of coins, the coins (5) will be inserted so that the selector (2) recognized and validates (6) them, the machine being prepared for the dispensing (7) of the desired product, the coins then going to the corresponding money box (8) of the machine, moment when the machine is prepared to start a new token (1) recognition process. As it conventionally happens, if the product is not dispensed the coins will be led to the return box.

In this way, when a user wishes to purchase cigarettes he should ask the person in charge or supervisor of the premises where the machine is installed for the corresponding token (1), in such a way that the person in charge of the premises solely and exclusively provides the tokens to those people of age who ask for them, whereas if a minor asks for a token (1), the token will not be provided and hence the purchase of cigarettes by the minor will be prevented.

Hence, once the user has obtained a token (1), free of charge, he will introduce it in the cigarette vending machine so that when the token is recognized and validated as good, the selector (2) for the validation of coins is activated, since on the contrary if coins are inserted without the corresponding token (1) having been previously inserted, the selector does not carry out any validation of the coins rejecting all of them.

In short it is a question of obtaining a totally reliable system in order to supervise that exclusively and only persons of age purchase cigarettes from cigarette vending machines, given that prior to the insertion and validation of the coins for the purchase of the desired product, a token (1) with certain characteristics, that should be provided by a person in charge of the premises where the machine is installed. should be introduced, in such a way that the token will only be provided to persons of age, preventing minors from being able to purchase cigarettes from vending machines.

Hence, the purpose of the tokens (1) is to produce the activation of the coin selector (2) for the validation thereof, once a token (1) has been recognized and validated by the selector itself (2), the coin validation time being limited to a predetermined amount of time.

1.- System for the activation of the coin selector for cigarette vending machines, being of the type of cigarette vending machines that include a coin selector for validation thereof, characterized in that the system includes activating means of the selector of the machine, for a certain amount of time, for the recognition of the coins inserted for the purchase of the desired product, supervising and controlling the sale of cigarettes.

2.- System for the activation of the coin selector for cigarette vending machines, according to claim 1, characterized in that the activating means of the coin selector are defined by a token (1) of specific characteristics recorded in the memory of the electronic control and operating system of the machine, a token which when it is inserted and recognized by the selector (2) the selector is activated for a certain amount of time for the validation of coins and the dispensing of a single product.

3.- System for the activation of the coin selector for cigarette vending machines, according to claim 1, characterized in that the coin selector (2) of the machine solely and exclusively validates coins (5) if the activating token (1) of the coin selector system has been previously inserted and recognized.

4.- System for the activation of the coin selector for cigarette vending machines, according to the preceding claims, characterized in that the supervision and control of the sale of cigarettes is defined by the activating token itself (1) of the coin (5) selector (2) since the token is provided by the person in charge of the premises where the cigarette vending machine is installed, the token being stored once it has been recognized by the selector (2) in a money box (4) of the machine itself, without the possibility of being returned to the receiving box.
